(19) United States
(12) Patent Application Publication
(10) Pub. No.: US 2006/0164676 A1
(43) Pub. Date: Jul. 27, 2006

(54) Subscriber service and micro-printer for remote, mobile printing

(75) Inventors: Jeffrey Warren Walker, Windham, NH (US); Mark J. Thirman, Wayland, MA (US); Peter K. Fichter, Newbury, NH (US); Samuel H. Liggero, Wellesley, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Airprint Networks, Inc., Wayland, MA (US)

(21) Appl. No.: 11/295,679

(22) Filed: Dec. 6, 2005

Related U.S. Application Data
(60) Provisional application No. 60/633,961, filed on Dec. 7, 2004.

(51) Int. Cl. G06F 3/12; G06F 15/16; G06F 15/00; G06K 1/00

(52) U.S. Cl. 358/1.15; 709/203

(57) ABSTRACT

Systems and methods for memorializing data from a portable communications device (e.g., a cellular phone or personal data assistant) are disclosed. One example is a system for providing printable files to a portable communications device. The system includes a portable communications device connected to a printing module. The portable communications device is also connected to a server, which is connected to one or more content providers. A user selected command from the portable communications device is received by a content provider, which returns an authorization signal to the server. The server, in turn, sends a printable file to the portable communications device, which is forwarded to the printing module to create media based on the file. Such a system can be utilized to conduct a commercial transaction (e.g., purchase of coupons or event tickets). Other aspects, such as security and creating printable image files, are also discussed.

### CROSS REFERENCE TO RELATED APPLICATIONS

This application claims the benefit of a U.S. Provisional Patent Application bearing Ser. No. 60/633,961 filed Dec. 7, 2004, the entire contents of which are hereby incorporated by reference herein.

### BACKGROUND OF THE INVENTION

The invention pertains to telecommunications and remote data memorialization. More particularly, it pertains to methods and apparatus for the provision of telecommunications subscriber services and remote printing.

A number of options exist for data to be gathered and to be printed and preserved on permanent media. Much of this data is provided from but not limited to the Web. The most common method for converting this data into printed form is by fixed printing devices as for example a printer connected to a computer. While many computers and printers today are transportable, they are not conveniently carried on one's person.

There is an increasing proliferation of portable communications devices, such as cellular telephones and personal data assistants (PDAs). To date, output from these devices has typically been audio and visual. Though these are suitable for many needs, such output does not address the wide ranging demands that might otherwise be met if that output could be permanently memorialized. Those demands include, by way of example, business transactions, remote data presentation, and so forth.

An object of this invention is to provide methods and apparatus for telecommunications service provision data memorialization. A more particular object, by way of example, is to provide such methods and apparatus for the provision of telecommunications subscriber services. A further object is to provide such methods and apparatus as permit the permanent (or semi-permanent) memorialization of output from portable communications devices, such as cellular phones and PDAs.

A still further object of the invention is to provide such methods and apparatus as can be implemented on top of a variety of telecommunications networks and/or with a variety of portable communications devices.

A still yet further object of the invention is to provide such methods and apparatus as can be implemented at low cost.

### SUMMARY OF THE INVENTION

The foregoing are among the objects attained by the invention which provides, among other aspects, methods and apparatus for telecommunications and/or network subscriber services and printing that enable portable communication device users (or “subscribers”) to print data and transactional content remotely, e.g., without having to dock with a personal computer.

Related aspects of the invention provide such methods and apparatus as employed in connection with remote printing of items of value such as, by way of non-limiting example tickets to entertainment events and coupons, micro-maps, content-of-the-day, transportation tickets, and more.

Still other related aspects of the invention provide such methods and apparatus which enable disparate content providers the ability to “lock” content into a format compatible with designated remote client application and printer interface applications.

Yet other related aspects of the invention provide such methods and apparatus which include content management capabilities that allow control of stored content by subscribers, including, by way of example, storing, printing, reporting, error reporting, and deleting such content.

The invention provides, in further aspects, systems and methods for transferring data over a telecommunications network to a remote device (such as a PDA or cellular phone), executing a commercial or other transaction on that device, providing secure and verifiable exchange of data over the network to the device, and printing that data on the device. Related aspects of the invention provide such systems and methods in which printing, at the remote device, is effected on a portable, conveniently configurable, light weight and inexpensive printer.

Further related aspects of the invention provide systems and method as described above in which the data to be printed is obtained from a data server that is coupled to the telecommunications network.

Still other related aspects of the invention provide such methods in which data transfer over the network and/or to the remote device is made through a permanent connection (such as a cable or interface connector), a wireless connection (such as Bluetooth, IrDA, WiFi), or otherwise.

In further related aspects, the invention provides such systems and methods in which data, once received by at the remote device, is converted from machine readable form to human readable form by the printer, resulting in a permanent paper record of the data to be used by the subscriber.

Other aspects of the invention provide systems and methods as described above in which images or other information recorded by the remote device itself (e.g., by way of an on-board camera, voice recorder, or the like) is recorded directly to the printer, e.g., irrespective of the telecommunications network.

Still other aspects of the invention provide such systems and methods as described above in which such information recorded or generated by the remote device (such as images, voice recording, reports, etc.) and/or the printer are transferred via the remote device, over the telecommunications network, to a central location. That information is then manipulated to alter or enhance the data content and retransmitted (e.g., either automatically or on subscriber request) to the remote device for printing, as described above.

### BRIEF DESCRIPTION OF THE DRAWINGS

A more complete understanding of the invention may be attained by reference to the drawings, in which:

FIG. 1 depicts a system according to one practice of the invention.

### DETAILED DESCRIPTION OF THE ILLUSTRATED EMBODIMENT

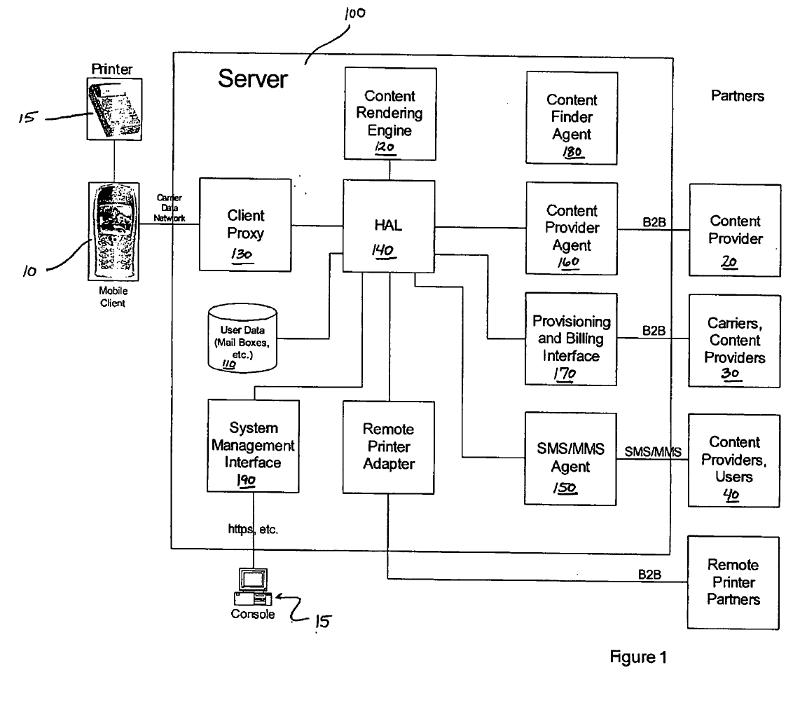

FIG. 1 depicts one embodiment of system according to the invention for provision of telecommunications subscriber services and remote printing. Descriptions of the components of the illustrated embodiment, and their interrelationships, follow. Those skilled in the art will appreciate that other embodiments may have few components or other components, in addition to or instead of those shown here, and that functionality and interrelationship of those components may vary from that described below. Moreover, it will be appreciated that components described below as “programs,” “application” or other software may, in other embodiments, be implemented in hardware and/or firmware and, conversely, that components described below as hardware may, in other embodiments, be partially (or, where applicable, fully) implemented in software and/or firmware.

System Overview

In general, one or more portable communications devices (i.e., mobile platforms) are in communication with one or more content providers over a communications network, which may be owned by a Carrier. A server can also be introduced to interact with the various entities. As well, a printer

The mobile client 10 is a program that executes on a mobile platform such as a cellular phone. The user interacts with the program to access catalog information and print content. It is understood that a mobile client can be provided by an external source or can be loaded into the mobile platform. As well, a mobile client can be embodied on a mobile platform in a form other than an executable program (e.g., a mobile client can be embodied as firmware and/or hardware).

The server component 100 is a program that runs on a server computer 15 which is accessible from the Internet by the mobile client 10. The server 100 interacts with the client 10 as well as Content Providers 20 and Carriers 30. The server 100 of FIG. 1 has a database component that is used to keep track of user accounts (e.g., the database can be housed in the HAL component 140). The server 100 also has a system management interface 190 that allows an operator to manipulate and configure the server 100.

The server computer can also be embodied as two or more discrete processors working in conjunction, and/or can be accessible through other types of communications networks besides the Internet (e.g., direct telecommunications lines or other type of network). As well, a server can be embodied as hardware and/or firmware, or other embodiments as recognized by those of ordinary skill in the art. Furthermore, the server of FIG. 1 described herein is described with reference to several functional components. Servers consistent with embodiment of the invention can utilize any subset of these functional components, or add additional functional components. As well, particular subsets of functional components of a server can operate on one or more pieces of hardware and/or firmware, or can be embodied as one or more programs that run on one or more processors.

The content provider 20 is an entity which owns content which has inherent value which the user may wish to purchase. Content, for example, may include things like movie tickets, coupons, or other media that can be exchanged for goods, services, or other items of value. The carrier 30 is an entity that owns the network on which the data connection between the mobile client and the server 100 use to communicate. In many cases, the carrier 30 may also own the mobile device that is leased to the user, such as a cellular phone or personal data assistant (PDA).

The various elements of the system in FIG. 1, and their associated potential functions, are described in greater detail herein.

Mobile Client

The mobile client 10 is an application that runs on the mobile device. This application is the system's interface to the user.

The mobile client 10 can perform any number of functions to facilitate communication with a server 100 and other entities, the system in FIG. 1 presenting a particular set of functions. For example, when an item is deposited in the user's mailbox 110, the user is notified in a similar fashion to that of the receipt of voice mail. The method of notification depends on the capability of the mobile device. Methods of notification can include things like a message waiting light and other indicating techniques known to those of ordinary skill in the art.

The mobile client 10 allows the user to browse and query available catalog items. The user can initiate queries with the mobile client 10 such as: “What movie theaters are close to zip code 12345?” The mobile client then gets back from the server 100 a list of catalog items and presents them to the user. The mobile client 10 also allows the user to select items from the catalog listings to acquire. The acquisition may take the form of a purchase of an item, such as a movie ticket, or a “free” item, such as a coupon. When the item is acquired, the server may initiate a transaction on behalf of the user that includes transfer of funds. The acquired item shall then be transferred to the client's mailbox 110 for later printing.

When the user chooses to print an item in the mailbox 110, the mobile client 10 initiates a connection to the server 100 to request the item. The item is then rendered and streamed through the mobile client 10 from the server 100 to the printer 15.

If the mobile client 10 has access to a camera, the mobile client 10 has the ability to capture images from the camera. The mobile client 10 also enables the user to annotate the picture with text, graphics and borders. When a user has completed the capture and annotation, he or she can choose to print the image or send it to another user 40 via multimedia messaging (MMS) or other messaging mechanisms, in which case the image appears in the mailbox 110 of that other user.

Content Rendering Engine

The content rendering engine 120 is a portion of the server 100 that transforms content into a form suitable for printing by the user selected printer. The rendering process takes into account several metrics when deciding how to optimally render the content.

The data bandwidth used to move data from the client 10 to the server 100 is considered when choosing rendering parameters. The rendering engine 120 can trade off image quality for data size, and thus transmission speed, if required.

The color reproduction capabilities of the target printer 15 are also considered when rendering the content. If the printer 15 is a two color, black or white printer, and the content has color components, the rendering engine will dither the source image to suit the capabilities of the target printer 15. The rendering engine 120 also takes into account the color space incompatibilities between the source content and the printer's color capabilities. If the source content has rich color and the printer 15 has limited color reproduction capabilities, the rendering engine 120 will do color mapping to optimize the printed image quality.

The parameter choices that the rendering engine 120 makes to scale content to fit the printer's form factor have a direct relationship to color reproduction and bandwidth. The rendering engine 120 makes trade-offs between color and image quality with this bandwidth utilization in mind.

The rendering engine 120 can also render non-image content, such as text and graphics. If the source content is in HTML form with embedded images, for example, the rendering engine can render this content with the target printer in mind. To support additional formats, the rendering engine 120 uses a pluggable design which allows plug-ins that support new content formats.

Though the content rendering engine shown in FIG. 1 utilizes the aforementioned metrics to create a printable file, other content rendering engines can utilize a subset of the metrics or add one or more additional metrics as known to those of ordinary skill in the art to any number of those previously discussed herein.

Client Proxy

The client proxy 130 is a component in the server architecture 100. This component is point of contact for the mobile client application 10. When the mobile client 10 initiates a connection back to the server 100, the client proxy 130 is the component in the server 100 that fields the connection. Client proxies can carry out a number of functionalities associated with the connection between a server and a mobile client, including the particular set of functionalities described herein with respect to FIG. 1.

When the server 100 wishes to notify the client of a message waiting in their mailbox 110, the server 100 does so by way of the client proxy 130. The client proxy 130 will check to see if there are any messages waiting in the user's mailbox 110 when the mobile client 10 connects, and is connected with the server 100. If there are new messages, the client proxy 130 will notify the mobile client 10, which will in turn assert a message waiting indicator.

The content sent between the mobile client 10 and the client proxy 130 is compressed to conserve bandwidth. The content is also encrypted for the transaction types that require the transmission of sensitive information.

The client proxy 130 will pass along annotated pictures from the mobile client 10 to the nucleus (HAL) 140, which will route the content to another user's mailbox 110 or to the MMS Agent 150, as required.

Nucleus (HAL)

The HAL component 140 is responsible for maintaining the state of the system, through the use of a database. The database is used to maintain information about the users, such as which particular mailbox is assigned to the user and what the user's fulfillment information is, in the event of content purchase.

The HAL component 140 arbitrates communication between the components. If captured photo content is sent from one user to another, for example, the HAL component 140 would handle the transaction.

Post Office

The post office component 110 contains the mailboxes for the users of the system. The post office 110 will initiate message waiting notification to users, by way of the client proxy 130, if the user's mobile client 10 is connected to the server 100.

Content Provider Agent

The content provider agent 160 is an adapter component that facilitates communication between the server 100 and partner content providers 20. The agent 160 adapts catalog queries from the client proxy 130 to the given Content Provider's Business to Business (B2B) interface. This content provider agent 160 allows the content provider specific code to be isolated. As new content providers are added, this component 160 will implement the same interface presented to the rest of the server 100, but the implementation will be tailored to the specific content provider.

The content provider agent 160 presents an interface to the system of FIG. 1 that allows catalog queries of the content provider 20. This interface allows the client proxy 130 to ask the content provider 20 for lists of catalog items that ultimately get passed back to the mobile client 10 and presented to the user.

When the user wishes to acquire an item, the content provider agent 160 presents an interface that allows the execution of the transaction. The catalog item is presented to the interface along with fulfillment information, if the fulfillment is required. At the completion of the transaction, an object or list of objects are given to the agent 160 by the content provider 20. These objects represent the content that was acquired from the content provider 20, such as a movie ticket.

When the system accepts external data, such as a printable object, metadata is carried with the object. The metadata contains information that is the same for all objects from all content providers 20 and information that is specific to the content provider 20 involved in the given transaction (or to that given transaction itself). Examples of metadata that apply to all content providers 20 are things like the date and time that the object was brought into the system. An example of a content provider-specific (or transaction-specific) information is the expiration date of a coupon.

In the event that partner content providers 20 have specific business rules, the system can accommodate this requirement. If the content provider 20 wishes to get notification of the state of an object to be “printed,” the system can execute a rule that results in a notification.

In some models, the content provider 20 may push content to the user, such as location based coupons. The content provider agent 160 can asynchronously receive the content objects mentioned above through this asynchronous receive interface. The objects are then routed to the user's mailbox 110.

Provisioning and Billing Interface

The provisioning interface 170 is used to create new and delete users. The interface 170 is designed to be flexible enough to support the diverse provisioning requirements that the carriers 30 and content providers 20 may have. The billing interface 170 is used to provide fulfillment for purchased items and usage fees, depending on the business model established with the carriers 30 and content providers 20. The provisioning interface 170 also has the ability to provide usage statistics about individual users and groups of users.

Short Message Service/Multimedia Messaging Agent

The short message service/multimedia messaging (SMS/MMS) agent 150 is responsible for any messaging traffic into and out of the system. This component can field messages from external sources, such as content providers 20. This allows leverage of existing broadcast techniques for pushing content to the users. This interface also allows messages to be sent from the system on behalf of a user.

Content Finder Agent

The content finder agent 180 is a component that searches for content based on user preferences. The user, for example, may set the agent 180 to look for coupons for coffee shops based on current GPS location. The user may also sign up for coupons of brands or categories of items. The agent 180 will occasionally search for content that meets the criteria.

Mobile Client to Client Proxy Protocol

The protocol used between the mobile client 10 and the client proxy 130 is required to be flexible to varying payload types, bandwidth friendly for low bandwidth applications, and secure. At the lowest layer, the TCP/IP protocol shall be used at the outset. Other transport protocols can be substituted as needed. The data stream is compressed using a ZipStream encode/decode technique. The data stream is also encrypted. The content of the stream uses XML to contain the objects being passed between the mobile client 10 and the client proxy 130. Non-text objects are encoded using MIME tags, similar to those used for e-mail enclosures. Clearly other types of compression and/or encoding/decoding techniques can be substituted when suitable for accommodating the needs of client proxy 130 and mobile client 10 communication.

The Printer

The printer 15 of the illustrated embodiment in FIG. 1 utilizes multiple heating elements to cause a reaction in thermally activated media to produce a human readable image of data presented to the printer 15 from a portable communications device. Various embodiments of the above printer are envisioned and presented in more detail below.

In one embodiment the printer is connected to a connected to a mobile device, such as a cellular phone, via an electrical terminal as well as suitable mechanical means, forming in effect a single instrument. The electrical connector provides a path for transmission of data as well as two way communication controlling functions of the printer, and reporting printer status information to the cell phone, as well as a means for obtaining electrical power from the power source within the cellular phone.

Due to the plurality of cellular phones available, and lack of standard electrical interconnections among the variety of phones, the printer is configured with an easily exchanged module, e.g., a face plate, which could be configured to provide a custom electrically connected interface for a plurality of phones.

Operational information from the printer may be of value to the user; hence such information is made available to the cellular phone and may be interpreted and displayed by the cellular phone for the benefit of the user.

The printer when connected to the cellular phone consists of a number of integral parts, an element with a number of heating elements which respond to data input from the communications source to cause elements to energize. A platen which forms the substrate for these elements, a roller which causes force to be exerted on the platen, a motor and gear elements which respond to an electrical impulse to enact rotation of the roller.

A mechanism which causes a single sheet of thermal sensitive media to be advanced into the space between the platen and roller and subsequently advance in response to an electrical impulse from control circuitry within the printer, from data provided via the cellular phone.

The action of this media movement through the platen/roller interface causes media to be advanced, as the media advances electrical signals from the circuits within the printer, energize one or more heating elements in response to data provided by the cellular phone which cause a reaction resulting in a readable mark on the media.

The media is subsequently advanced a specified increment and the process is repeated, this process continues until the entire length of one media sheet has been transported through the platen/roller interface and has been energized to form a readable mark in response to the data transferred by the cellular phone.

The printer contains a door or opening accessible to the user for inserting one or multiple sheets of pre cut media into the printer for storage and subsequent printing as described above in response to commands from the cellular phone.

The media may be inserted individually or as a group in some form of cassette.

The printer is also equipped with an exit slot which allows the media to emerge from the printer and be made available to the user in the form of a permanent record.

The printer also contains a number of mechanisms which report the status of media in the printer and to monitor a number of functions, including out of media condition, jammed media condition, and insufficient available power to initiate a complete print cycle. This later would prevent a condition were a print cycle was initiated but insufficient power existed to assure completion of the entire print cycle. An algorithm is incorporated to make prior estimates of print cycle energy requirements.

The printer also includes an access so that malfunctions, such as paper jams, or service, such as cleaning the platen, can be accomplished by the user.

An alternate embodiment of the above printer provides for a separate power source, such as a battery as an integral component of the printer. T his has the advantage of increasing the overall energy capacity of the system, allowing both the cellular phone and printer to operate on independent power sources.

In utilizing separate power sources the printer could be provided with a recharging means for its internal battery, or could be configured to share the recharging mechanism provided with the cellular phone.

Yet another embodiment would include separate power sources for both the cellular phone and the printer, these power sources could be internally shared increasing the power available individually to either the cellular phone or printer to increase individual operational time.

Another embodiment of the printer retains the printer physically separate and unique from the cellular phone or other communications device, using wireless communications methods, such as Bluetooth, IrDA, WiFi or similar technology, to communicate data to the printer from the communications device and allow transfer of operational information to transmit between the communications device and printer as well as printer to communications device.

Yet another embodiment of the printer is as part of a vehicular communications environment, where, for example, a printer as defined above could form a permanent component within a vehicle. In this embodiment a communications device such as cellular phone or PDA could exchange data with the printer via electrical connector or alternately with a wireless method such as Bluetooth, IrDA, WiFi or similar technology.

When the printer is incorporated into a vehicular communications environment, the power source to operate the printer could be derived from the internal power source of the vehicle, extending the operational capability of the printer.

Printer/Portable Communications Device Connection

The requirements on connection mechanism between the mobile client 10 and the printer 15 are increased when the content to be printed has intrinsic value. With normal printing operations, the user can simply try printing the item again. With items of value, the content's value is transferred to paper during to printing operation. If there is an error in this transfer operation and the content is unusable and the system thinks the operation was successful, the value is essentially lost.

A secure connection between the printer 15 and the mobile client 10 can hinder an unintended party from recording the content that is being printed out and producing multiple copies of the item of value. One could conceive that it is possible for an entity to pose as the printer to capture the electronic item. That same entity could then pose as the handset client and “play back” the content to the printer to print out multiple copies of the item.

In a similar fashion, the connection can be robust enough to guard against “man in the middle” attacks. In this “man in the middle” scenario, an entity is “sniffing” the data passing back and forth between the mobile client 10 and the printer 15. The protocol between the printer 15 and the mobile client 10 is then reverse engineered. With this knowledge, the mobile client 10 is emulated and then provides the ability to print out multiple copies of the item of value.

The connection between the printer 15 and the mobile client 10 can also have enhanced reliability. If data corruption in the transmission of the data between the mobile client 10 and the printer 15 occurs, the corruption must be detected and a retransmission requested. If the corruption is not detected, an artifact in the printed output may occur rendering the printed content useless.

The printer 15 can also have the ability to notify the mobile client 10 of the success or failure to render the item of value to paper. If the printer 15 encounters an error, the printer 15 can notify the mobile client 10 of the error. The mobile client 10 can then inform the user of the error and allow them to retry the printing operation. The mobile client 10 may also notify the server 100 of the error such that error statistics can be collected. The server 100 could notify the content provider 20 of errors, if the content provider 20 wishes such error notification. The printer 15 is advantageously very robust in its error detection. Errors such as paper jams, and low battery conditions can be detected and reported to the mobile client.

In an exemplary embodiment, a protocol between the printing module and the mobile client uses an encryption algorithm to ensure security. This encryption algorithm provides security by guarding against “man in the middle” attacks as well as “record and playback” attacks. Encryption algorithms include the variety of those utilized by those of ordinary skill in the art, and which are appropriate for use by a printing module and/or a portable communications device (e.g., algorithms which are overly complex to be used by the devices would not optimal). Encryption of a printable file sent from a portable communications device to a printing module can be performed by the server or by the portable communications device. As well, the printing module can be adapted to decode the printable file before creating the printed media. In many instances, a printing module includes a processor and/or other appropriate mechanism in communication with a printer for performing one or more of the connection functions described herein.

In another exemplary embodiment, the protocol between the portable communications device and printing module can include a header with the transferred printable file that contains a predetermined packet length value and checksum to ensure reliability. If the packet checksum, determined by the printing module upon transfer of the packet, does not match, the printing module returns a NACK signal which asks the portable communications device to retransmit the packet. When the packet is successfully processed, the printing module returns an ACK which acknowledges the packet. The protocol can also support a final “printed successfully” message or “error X encountered” message back to the portable communications device. This message notifies the personal communications device of the final disposition of the printed content. Clearly, any one of the functions of this embodiment can be utilized separately in a system or combined with the encryption features previously described.

Described and illustrated herein are embodiments meeting the objects set forth above. Those skilled in art will appreciate that these embodiments are merely examples of the invention and that other embodiments, incorporating changes, therein fall within the scope of our invention.

What is claimed is:

1. A system for providing printable files to a portable communications device, the system comprising:
at least one portable communications device for sending a user-selected command;
at least one content provider for sending an authorization message upon receiving the user-selected command;
a server in communication with the at least one portable communications device and the at least one content provider, the server adapted to route the user-selected command to the at least one content provider upon receiving the user-selected command from the at least one portable communications device, and to send a printable file to the at least one portable communications device after receiving the authorization message; and
a printing module in communication with the at least one portable communications device, the printing module adapted to create printed media based upon the printable file received from the at least one portable communications device.

2. The system of claim 1, wherein the at least one portable communications device is at least one of a cellular phone and a personal data assistant.

3. The system of claim 1, wherein the server and the at least one portable communications device are adapted to be in wireless communication.

4. The system of claim 1, wherein the server is adapted to provide the printable file in a format depending upon at least one of the at least one portable communications device and the printing module.

5. The system of claim 1, wherein the server is adapted to send the authorization message as at least a portion of the printable file.

6. The system of claim 1, wherein the server includes a data server for storing at least a portion of the printable file sent by the server.

7. The system of claim 6, wherein the data server is adapted to store data provided from the at least one content provider to the server.

8. The system of claim 6, wherein the data server is adapted to remove data from the data server after the server receives a remove command from the at least one content provider.

9. The system of claim 1, wherein the printing module is adapted to be portable.

10. A method for memorializing data from a portable communications device, the method comprising:
sending a user-selected command from the portable communications device;
routing the user-selected command to a content provider;
returning an authorization message from the content provider in response to the user-selected command;
providing a printable file to the portable communications device based at least in part on the authorization message; and
printing media using a printing module that is in communication with the portable communications device, the printed media based at least in part on the printable file.

11. The method of claim 10, wherein the method executes a commercial transaction.

12. The method of claim 10, further comprising sending a query from the content provider to the portable communications device to provide selectable choices for the user-selected command.

13. The method of claim 10, wherein the step of returning an authorization message occurs asynchronously with the receipt of the user-selected command.

14. The method of claim 10, wherein the step of providing the printable file to the portable communications device includes sending the printable file to an electronic mailbox, the portable communications device retrieving the printable file from the electronic mailbox.

15. The method of claim 10, wherein the step of printing media includes printing media that is exchangeable for a product or service.

16. The method of claim 10, wherein the step of providing the printable file includes retrieving at least a portion of the printable file from a data server.

17. The method of claim 10, wherein the step of providing the printable file includes formatting the printable file according to at least one of a characteristic of the printing module, a characteristic of the portable communications device, and a communications bandwidth to the portable communications device.

18. A system for providing printed media based upon data provided by a portable communications device, the system comprising:
a first portable communications device for providing data to be processed into a printable file;
a server in communication with the first portable communications device for receiving the data, the server adapted to process the data into a printable file that is returned to the first portable communications device; and
a printing module in communication with the first portable communications device for providing printed media based upon the printable file received from the first portable communications device.

19. The system of claim 18, wherein the data provided by the first portable communications device includes image data.

20. The system of claim 18, wherein the first portable communications device includes a camera.

21. The system of claim 18, wherein the server processes the data into the printable file depending upon at least one of the first portable communications device and the printing module.

22. The system of claim 18, further comprising:
a second portable communications device, in communication with the server, for providing data, and
wherein the server is adapted to process data from the second portable communications device into a second printable file, the first portable communications device being adapted to receive the second printable file from the server.

23. A system for creating printed media from files sent by a portable communications device, the system comprising:
a portable communications device for receiving a printable file from a communications network; and
a printing module in communication with the portable communications device for creating printed media based upon the printable file received from the portable communications device.

24. The system of claim 23, wherein the portable communications device is adapted to send a selection signal to the communications network, the printable file received by the portable communications device based at least in part on the selection signal.

25. The system of claim 23, wherein the portable communications device is at least one of a personal data assistant and a cellular phone.

26. The system of claim 23, wherein the portable communications device is adapted to send an encrypted printable file to the printing module.

27. The system of claim 26, wherein the portable communications device is adapted to encrypt the printable file.

28. The system of claim 23, wherein the printing module is adapted to send an indicator signal to the portable communications device based upon at least one of receipt of the printable file and production of the printed media.

29. The system of claim 28, wherein the portable communications device forwards the indicator signal to a device on the communications network.

30. The system of claim 23, wherein the printing module is adapted to identify a predetermined packet length value in the printable file from the portable communications device, and to send a successful indicator signal to the portable communications device if the predetermined packet length value matches a measure of a packet length of the printable file.

31. The system of claim 23, wherein the printing module is adapted to identify a predetermined packet length value in the printable file from the portable communications device, and to send an unsuccessful indicator signal to the portable communications device if the predetermined packet length value does not match a measure of a packet length of the printable file.

32. The system of claim 23, wherein the printing module is adapted to send a completion indicator signal to the portable communications device after successful production of the printed media.

33. The system of claim 23, wherein the printing module is portable.

34. The system of claim 23, wherein the printing module includes a power source independent from a power source for the portable communications device.

35. The system of claim 23, wherein the printing module is at least a portion of a vehicular communications environment.

36. A method for protecting communications between a portable communications device and a printing module, comprising:
sending a printable file from the portable communications device to the printing module, the printable file being previously received from a communications network; and
sending an indicator signal from the printing module to the portable communications device after the printing module receives the printable file, the indicator signal based upon at least one of receipt of the printable file and creation of printed media derived from the printable file.

37. The method of claim 36, wherein the step of sending a printable file includes sending an encrypted printable file, the method further comprising decoding the encrypted file with the printing module.

38. The method of claim 37, further comprising encrypting the printable file with the portable communications device before sending the encrypted printable file with the portable communications device.

39. The method of claim 36, wherein the step of sending a printable file includes sending a predetermined packet length value with the printable file.

40. The method of claim 39, further comprising:
determining a measure of a packet length of the printable file with the printing module after sending the printable file from the portable communications device; and
comparing the measure of the packet length against the predetermined packet length value,
wherein the step of sending an indicator signal includes sending a successful indicator signal from the printing module to the portable communications device if the measure of packet length matches the predetermined packet length value.

41. The method of claim 40, wherein the step of sending an indicator signal includes sending an unsuccessful indicator signal from the printing module to the portable communications device if the measure of packet length does not match the predetermined packet length value.

42. The method of claim 36, wherein the step of sending an indicator signal includes sending a completion signal from the printing module to the portable communications device after successful production of printed media by the printing module.

43. The method of claim 36, further comprising performing a financial transaction between a user of the portable communications device and a content provider over the communications network, the content provider sending the printable file to the portable communications device over the communication network after performing the financial transaction.
